(19) United States
(12) Patent Application Publication
(10) Pub. No.: US 2026/0329611 A1
(43) Pub. Date: Oct. 22, 2026

(54) SCALABLE PROVISIONING OF BARE METAL SERVERS

(71) Applicant: Super Micro Computer, Inc., San Jose, CA (US)

(72) Inventors: Suiong NG, New Taipei (TW); Jhe-Wei JHANG, New Taipei (TW); Shu-Chun YEH, New Taipei (TW)

(21) Appl. No.: 19/181,661

(22) Filed: Apr. 17, 2025

(51) Int. Cl. G06F 9/455; G06F 9/445

(52) U.S. Cl. CPC G06F 9/45541; G06F 9/44505

(57) ABSTRACT

Disclosed is a system and method for provisioning bare metal servers. A baseboard management controller (BMC) sets up virtual media on a bare metal server. The BMC boots from one virtual media, and configuration information of the bare metal server is retrieved from another virtual media. Hardware components of the bare metal server are configured using the configuration information.

### TECHNICAL FIELD

The present disclosure is directed to server computers.

### BACKGROUND

Bare metal provisioning involves configuring physical server hardware by installing an operating system and necessary software directly onto the hardware, without using virtualization layers. Two common techniques for bare metal provisioning include virtual media-based provisioning and network-based provisioning.

In virtual media-based provisioning, a baseboard management controller (BMC) mounts a bootable virtual image on a virtual media. The server then boots from the virtual media to install an operating system. Systems such as OpenStack Ironic may employ virtual media-based provisioning to manage bare metal servers.

In network-based provisioning, protocols such as Preboot Execution Environment (PXE) or iPXE are used. The server performs a network boot to retrieve bootloaders and operating system images directly over the network, without the need for virtual media mounting.

While these techniques are widely used, scaling bare metal provisioning to a large number of devices introduces several challenges. As the number of bare metal servers increases, the consumption of network bandwidth grows significantly, particularly due to the repeated transfer of large installation images. Additionally, coordinating the provisioning process across multiple servers can introduce operational complexity, including management of image delivery, boot sequencing, and configuration retrieval.

### BRIEF SUMMARY

In one embodiment, a method of provisioning a bare metal server includes a baseboard management controller (BMC) of a bare metal server setting up a first virtual media on the bare metal server responsive to receiving a first request over a BMC network, wherein a bootable main virtual image is mounted on the first virtual media. The BMC sets up a second virtual media on the bare metal server responsive to receiving a second request over the BMC network, wherein a configuration virtual image containing configuration information of the bare metal server is mounted on the second virtual media. The BMC boots from the first virtual media. Configuration information of the bare metal server is retrieved from the second virtual media and is used to configure one or more hardware components of the bare metal server.

In another embodiment, a controller server comprises at least one processor that executes instructions to cause the controller server to: send a first request to a first BMC of a first bare metal server to set up a first virtual media on the first bare metal server; send a second request to the first BMC to set up a second virtual media on the first bare metal server; send a first boot request to the first BMC to boot from the first virtual media and thereby cause configuration information of the first bare metal server to be retrieved from the second virtual media; send a third request to a second BMC of a second bare metal server to set up a third virtual media on the second bare metal server; send a fourth request to the second BMC to set up a fourth virtual media on the second bare metal server; and send a second boot request to the second BMC to boot from the third virtual media and thereby cause configuration information of the second bare metal server to be retrieved from the fourth virtual media.

In yet another embodiment, a method of provisioning a bare metal server includes setting up a first virtual media and a second virtual media on the bare metal server. The bare metal server boots from the first virtual media and retrieves configuration information of the bare metal server from the second virtual media. One or more hardware components of the bare metal server are configured in accordance with the configuration information.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a block diagram of a provisioning system, in accordance with an embodiment of the present invention.

FIG. 2 shows a call diagram of a method of preparing a virtual image to allow for provisioning bare metal servers using multiple virtual media, in accordance with an embodiment of the present invention.

FIG. 3 shows a call diagram of a method of provisioning bare metal servers, in accordance with an embodiment of the present invention.

FIG. 4 shows a block diagram of a computer system that may be employed with embodiments of the present invention.

### DETAILED DESCRIPTION

In the present disclosure, numerous specific details are provided, such as examples of systems, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

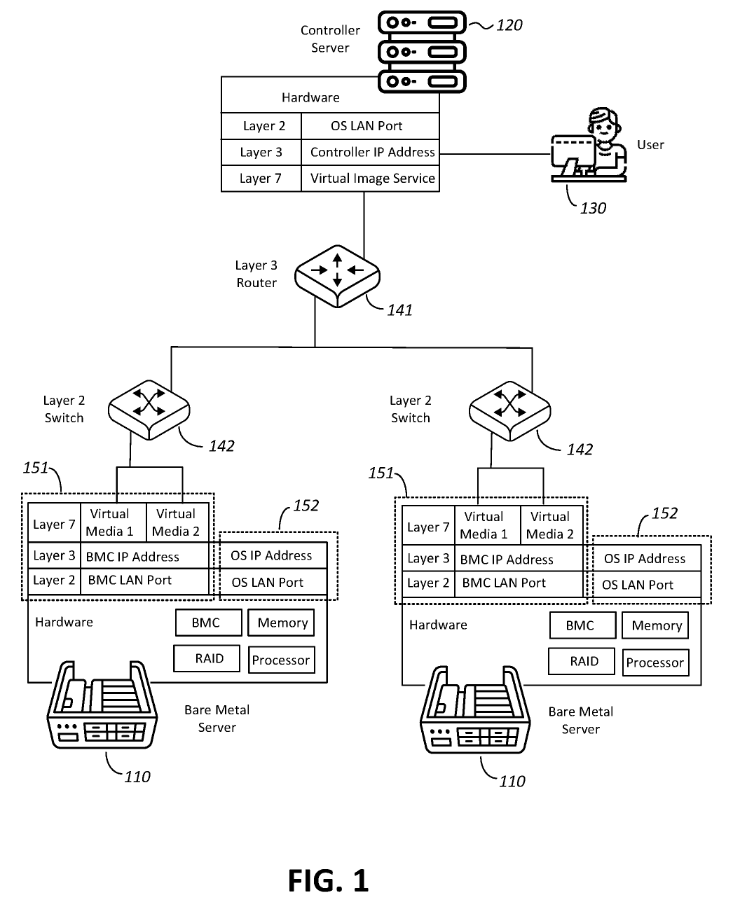

FIG. 1 shows a block diagram of a provisioning system, in accordance with an embodiment of the present invention. The system of FIG. 1 includes a controller server 120 and a plurality of bare metal servers 110. Only two bare metal servers 110 are shown in FIG. 1 for clarity of illustration.

A bare metal server 110 may include a baseboard management controller (BMC), at least one processor, main memory, data storage devices (e.g., Redundant Array of Independent Disks (RAID) arrays), non-volatile memory containing Basic Input/Output System (BIOS), and other hardware components. However, before provisioning, the bare metal server 110 does not include any pre-installed operating system.

Generally, bare metal servers can communicate over two types of communication networks, namely a control plane network and a data plane network. Open Systems Interconnection (OSI) layers associated with the control plane network, which is also known as a BMC network or out-of-band admin network, are represented in FIG. 1 by a dashed box 151. OSI layers associated with the data plane network, which is also known as the operating system or tenant network, are represented in FIG. 1 by a dashed box 152. In the example of FIG. 1, the controller server 120 and BMCs of the bare metal servers 110 communicate over the BMC network, i.e., control plane network, by way of a layer 3 router 141 and layer 2 switches 142.

In FIG. 1, it is to be noted that there are no lines connecting the dashed box 152 (i.e., data plane network) to the controller server 120. This is because embodiments of the present invention do not necessarily need to provision over the data plane network. Advantageously, embodiments of the present invention may provision a bare metal server exclusively over the BMC network. This is in marked contrast to conventional provisioning processes that require communications over the data plane network or both the data plane network and the BMC network.

FIG. 1 illustrates the OSI model layers associated with the bare metal server 110. The local area network (LAN) port of the BMC operates at layer 2 of the OSI model, and the Internet Protocol (IP) address of the BMC operates at layer 3. The controller server 120 may communicate with the bare metal server 110 via the BMC’s IP address and LAN port, through the layer 3 router 141 and the layer 2 switch 142. As will be described in more detail below, the controller server 120 may instruct the BMC to set up and attach a plurality of virtual media (“Virtual Media 1,” “Virtual Media 2”). The plurality of virtual media operates at layer 7 of the OSI model.

“Virtual media” refers to a virtualized representation of a physical storage device (e.g., a virtual CD/DVD-ROM drive or USB drive). “Virtual image” refers to a file or data structure containing the contents of a virtual storage device, such as an ISO file representing an operating system installer or configuration data. A virtual image may be mounted onto virtual media, allowing a computing device to read the contents of the virtual image through the virtual media.

For purposes of the present disclosure, a main virtual image refers to a bootable image. The main virtual image may comprise an ephemeral operating system, a production operating system, and a provisioning program. As its name indicates, the ephemeral operating system is temporary in that it is used primarily to boot the bare metal server 110 for provisioning; the ephemeral operating system is removed after completion of the provisioning process. In contrast, the production operating system is the installed operating system of the bare metal server 110 for normal operation.

The provisioning program may comprise software for configuring hardware components of the bare metal server 110, such as the BMC, BIOS, and data storage (e.g., RAID arrays). The provisioning program may also comprise an installer for installing the production operating system.

In one embodiment, the BMC mounts the main virtual image onto a first virtual media, and boots from the first virtual media to cause the ephemeral operating system to execute. The provisioning program runs under the ephemeral operating system and retrieves configuration information of the bare metal server 110 from a configuration virtual image mounted on a second virtual media. The provisioning program configures the bare metal server 110 in accordance with the configuration information. The provisioning program or another installer may install the production operating system on the bare metal server 110. The ephemeral operating system is removed at the completion of the provisioning process, such as by rebooting the bare metal server 110 and detaching the first and second virtual media.

The controller server 120 includes hardware and software components configured to perform provisioning of the bare metal servers 110 in conjunction with corresponding BMCs. The controller server 120 may be implemented as a single physical server, as a plurality of interconnected servers, a virtual machine, a software container, as a distributed computing environment, etc. The controller server 120 communicates with BMCs of the bare metal servers 110 over the BMC network.

In the example of FIG. 1, the controller server 120 has an IP address operating at layer 3 of the OSI model, a LAN port operating at layer 2, and a virtual image service operating at layer 7. A user (e.g., an administrator) may employ a user computer 130 to upload the main virtual image to the controller server 120. The main virtual image may be modified to enable reading from an additional virtual media. During the provisioning process, the virtual image service of the controller server 120 works in conjunction with the BMC of each bare metal server 110 to enable booting from a virtual media containing the main virtual image and retrieve configuration information of the bare metal server 110 from the additional virtual media. The provisioning process may be initiated by the user.

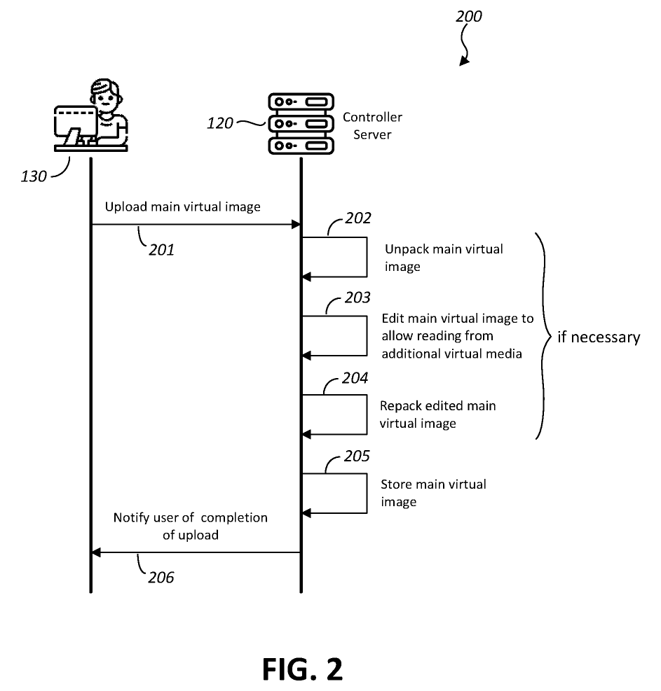

FIG. 2 shows a call diagram of a method 200 of preparing a virtual image to allow for provisioning bare metal servers using multiple virtual media, in accordance with an embodiment of the present invention.

In the example of FIG. 2, the user, employing the user computer 130, uploads the main virtual image to the controller server 120 (see arrow 201). On the controller server 120, the main virtual image is unpacked (see arrow 202), edited (see arrow 203), and repacked (see arrow 204) as necessary. More particularly, on the controller server 120, the main virtual image may be edited to allow for reading from additional virtual media (see arrow 203), and repacked after the editing process to incorporate the additional virtual media (see arrow 204). In one embodiment, the main virtual image is edited such that a provisioning program in the main virtual image can read configuration information from the additional virtual media. The edited main virtual image thus allows for reading from at least two virtual media: a first virtual media that is pre-existing in the main virtual image and a second virtual media that is added through the editing process. Accordingly, the main virtual image and the configuration virtual image may be mounted onto two separate virtual media on a bare metal server 110.

Separating the main virtual image from the configuration virtual image advantageously allows the bare metal servers 110 to use the same main virtual image. The main virtual image typically has an installer or live operating system image that contains the core application and all necessary components, making it quite large. In contrast, the configuration virtual image, although tailored for a particular bare metal server, is lightweight. Separating the main virtual image and configuration virtual image into two distinct virtual media advantageously allows for optimized storage, faster and more efficient image generation, and scalable provisioning.

The main virtual is stored on a storage device of, or accessible to, the controller server 120 (see arrow 205). The user is thereafter notified of the completion of the upload process (see arrow 206).

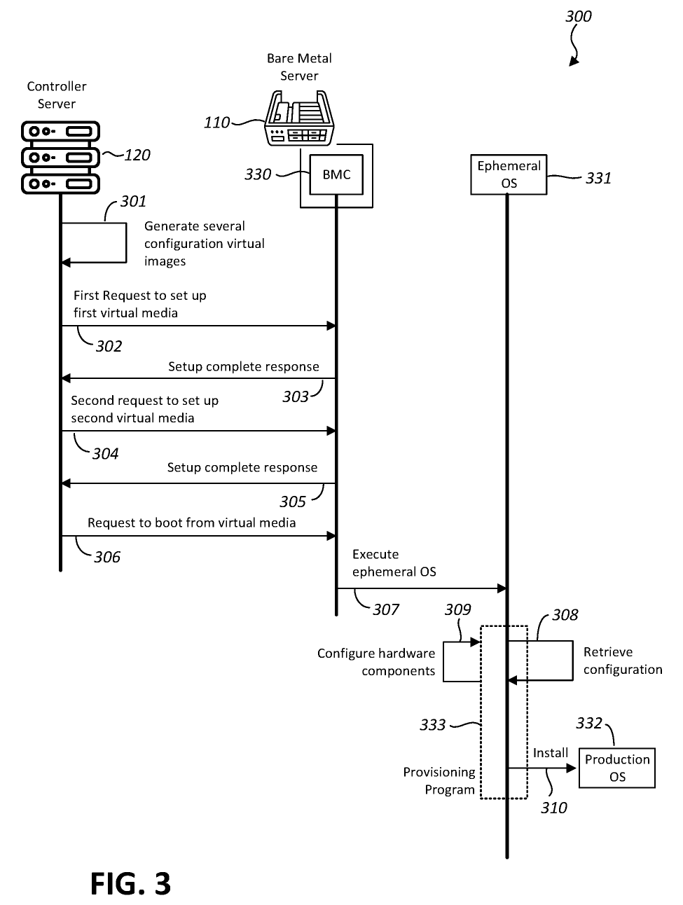

FIG. 3 shows a call diagram of a method 300 of provisioning bare metal servers, in accordance with an embodiment of the present invention. The method 300 may be performed to provision multiple bare metal servers 110 in parallel operations, but is described in the context of a single bare metal server 110 for clarity of illustration. In FIG. 3, the communications between the controller server 120 and a BMC 330 of a bare metal server 110 are over the BMC network.

In the example of FIG. 3, on the controller server 120, a plurality of configuration virtual images are generated (see arrow 301). Each configuration virtual image contains configuration information specific to a particular bare metal server 110. Examples of configuration information include configuration for the BMC 330, RAID array, BIOS, etc. of the bare metal server 110.

The controller server 120 sends a first request to the BMC 330 of the bare metal server 110 to set up a first virtual media for a first virtual image (see arrow 302). Responsive to the request, the BMC 330 sets up and attaches the first virtual media, and mounts the first virtual image onto the first virtual media. The BMC 330 may read the first virtual image on-the-fly (i.e., as needed). In one embodiment, the first virtual image is the main virtual image that has been edited to incorporate references to additional virtual media. After servicing the first request, the BMC 330 replies with a setup complete response to the controller server 120 (see arrow 303).

The controller server 120 sends a second request to the BMC 330 to set up a second virtual media for a second virtual image (see arrow 304). Responsive to the request, the BMC 330 sets up and attaches the second virtual media, and mounts the second virtual image onto the second virtual media. In one embodiment, the second virtual image is the configuration virtual image for the bare metal server 110. After servicing the second request, the BMC 330 replies with a setup complete response to the controller server 120 (see arrow 305).

After the first and second virtual media have been set up, the controller server 120 sends a boot request to the BMC 330 to boot the bare metal server 110 from one of the virtual media, which in this example is the first virtual media (see arrow 306). Responsive to the boot request, the BMC 330 initiates booting of the bare metal server 110 from the first virtual media by executing the ephemeral operating system (see arrow 307) included in the main virtual image mounted on the first virtual media. A provisioning program 333 included in the main virtual image executes under the ephemeral operating system 331, and reads from the second virtual media the configuration corresponding to the bare metal server 110 (see arrow 308). The provisioning program 333 configures one or more hardware components of the bare metal server 110 in accordance with the configuration information (see arrow 309). The provisioning program 333 or another installer may also install the production operating system 332 (see arrow 310), which may be read from the first virtual media.

The bare metal server 110 may be configured to power down after configuration of the hardware components or after installation of the production operating system 332, depending on the particulars of the provisioning process. The power down removes the ephemeral operating system 331 from the memory of the bare metal server 110. Upon reboot, the BMC 330, responsive to a request from the controller server 120, detaches/unmounts the first and second virtual media to ensure that the ephemeral operating system 331 is totally removed from the bare metal server 110.

Depending on available virtual media slots, the first and second virtual media may be the same or different types of virtual media. For example, each of the first and second virtual media may be a virtual CD/DVD-ROM drive. As another example, the first virtual media may be a virtual CD/DVD-ROM drive, whereas the second virtual media may be a virtual floppy drive. In cases where there is only one available virtual media slot, one of the virtual media may be replaced with a physical media, such as a physical Universal Serial Bus (USB) drive. For example, a physical USB drive may contain the main virtual image, and the configuration virtual image may be mounted on a virtual floppy drive.

Embodiments of the present invention provide advantages in terms of provisioning speed, networking efficiency, and storage capacity. First, in contrast to using a single virtual media, building a virtual image for each bare metal server will not be a limiting factor, because only the configuration information of the bare metal server needs to be built. There will be no delays waiting for the virtual image to build, allowing provisioning to be done concurrently. Second, using the same main virtual image for multiple bare metal servers opens up the possibility of a caching reverse proxy or using a content distribution network (CDN). Network traffic can be distributed to prevent local congestion, ensuring scalability without a single point of failure. Third, the resulting smaller size of the individual virtual images reduces storage space requirements and lowers the bandwidth needed for the storage network.

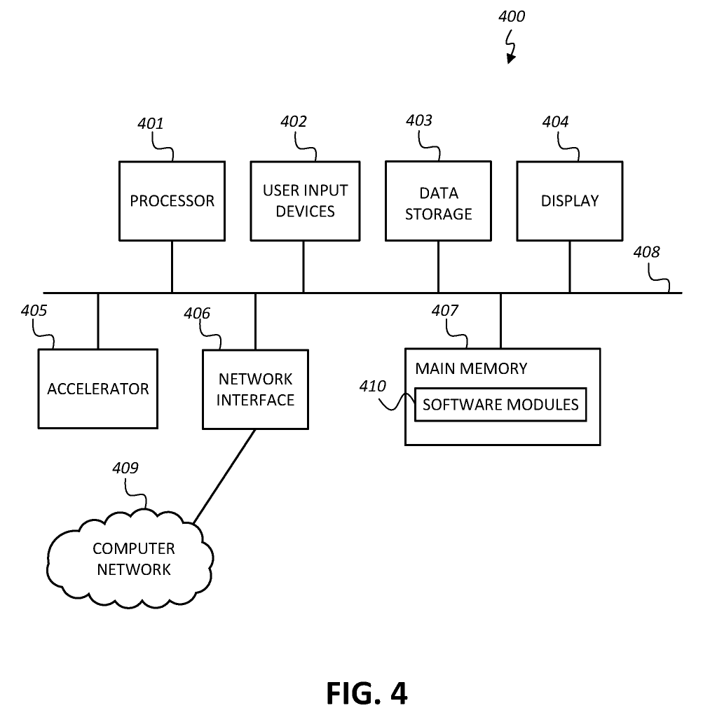

FIG. 4 shows a block diagram of a computer system 400 that may be employed with embodiments of the present invention. The computer system 400 may be employed as a controller server or other computer described herein. The computer system 400 may have fewer or more components to meet the needs of a particular application. The computer system 400 may include one or more processors 401, one or more user input devices 402 (e.g., keyboard, mouse), one or more data storage devices 403 (e.g., hard drive, optical disk, solid state drive), a display screen 404 (e.g., liquid crystal display, flat panel monitor), one or more accelerators 405 (e.g., graphics processing unit (GPU), neural processing unit (NPU)), a computer network interface 406 (e.g., network adapter, modem), and a main memory 407 (e.g., random access memory). The computer system 400 may have one or more buses 408 coupling its various components. The computer network interface 406 may be coupled to a computer network 409, which may be a BMC network or a data plane network.

The computer system 400 is a particular machine as programmed with one or more software modules 410, comprising instructions stored non-transitory in the main memory 407 for execution by at least one processor 401 to cause the computer system 400 to perform corresponding programmed steps. An article of manufacture may be embodied as computer-readable storage medium including instructions that when executed by at least one processor 401 cause the computer system 400 to be operable to perform the functions of the one or more software modules 410.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A method of provisioning bare metal servers, the method comprising:
setting up a first virtual media on a first bare metal server responsive to receiving a first request over a baseboard management controller (BMC) network, wherein a first main virtual image for booting the first bare metal server is mounted on the first virtual media;
setting up a second virtual media on the first bare metal server responsive to receiving a second request over the BMC network, wherein a first configuration virtual image containing configuration information of the first bare metal server is mounted on the second virtual media;
booting the first bare metal server from the first virtual media;
retrieving the configuration information of the first bare metal server from the second virtual media; and
configuring a hardware component of the first bare metal server in accordance with the configuration information of the first bare metal server.

2. The method of claim 1, further comprising:
setting up a third virtual media on a second bare metal server responsive to receiving a third request over the BMC network, wherein a second main virtual image is mounted on the third virtual media;
setting up a fourth virtual media on the second bare metal server responsive to receiving a fourth request over the BMC network, wherein a second configuration virtual image containing configuration information of the second bare metal server is mounted on the fourth virtual media;
booting the second bare metal server from the third virtual media;
retrieving the configuration information of the second bare metal server from the fourth virtual media; and
configuring a hardware component of the second bare metal server in accordance with the configuration information of the second bare metal server,
wherein the first main virtual image is the same as the second main virtual image, and the first configuration virtual image is different from the second configuration virtual image.

3. The method of claim 2, wherein each of the first and third virtual media is a virtual CD-ROM drive.

4. The method of claim 2, wherein each of the second and fourth virtual media is a virtual floppy drive.

5. The method of claim 2, wherein the first bare metal server boots from the first virtual media to execute a first ephemeral operating system on the first bare metal server responsive to receiving a fifth request over the BMC network, and the second bare metal server boots from the third virtual media to execute a second ephemeral operating system on the second bare metal server responsive to receiving a sixth request over the computer network.

6. The method of claim 5, wherein the first, second, third, fourth, fifth, and sixth requests are sent by a controller server over the BMC network, the first main virtual image is provided by the controller server to a first BMC of the first bare metal server, the second main virtual image is provided by the controller server to a second BMC of the second bare metal server, the first configuration virtual image is provided by the controller server to the first BMC, and the second configuration virtual image is provided by the controller server to the second BMC.

7. A controller server comprising at least one processor that executes instructions to cause the controller server to:
send a first request to a first baseboard management controller (BMC) of a first bare metal server to set up a first virtual media and mount a first main virtual image on the first virtual media on the first bare metal server;
send a second request to the first BMC to set up a second virtual media on the first bare metal server;
send a first boot request to the first BMC to boot from the first virtual media to execute a first ephemeral operating system on the first bare metal server and thereby cause a configuration information of the first bare metal server to be retrieved from the second virtual media;
send a third request to a second BMC of a second bare metal server to set up a third virtual media and mount a second main virtual image on the third virtual media on the second bare metal server;
send a fourth request to the second BMC to set up a fourth virtual media on the second bare metal server; and
send a second boot request to the second BMC to boot from the third virtual media to execute a second ephemeral operating system and thereby cause a configuration information of the second bare metal server to be retrieved from the fourth virtual media.

8. The controller server of claim 7, wherein each of the first and third virtual media is a virtual CD-ROM drive.

9. The controller server of claim 7, wherein each of the second and fourth virtual media is a virtual floppy drive.

10. A method of provisioning bare metal servers, the method comprising:
booting a first bare metal server from a first virtual media on the first bare metal server;
retrieving configuration information of the first bare metal server from a second virtual media on the first bare metal server; and
configuring a hardware component of the first bare metal server in accordance with the configuration information of the first bare metal server.

11. The method of claim 10, further comprising:
booting a second bare metal server from a third virtual media on the second bare metal server;
retrieving configuration information of the second bare metal server from a fourth virtual media on the second bare metal server; and
configuring a hardware component of the second bare metal server in accordance with the configuration information of the second bare metal server.

12. The method of claim 10, wherein the first virtual media is a virtual CD-ROM drive.

13. The method of claim 10, wherein the second virtual media is a virtual floppy drive.

14. The method of claim 11, wherein a first baseboard management controller (BMC) of the first bare metal server sets up the first virtual media on the first bare metal server responsive to receiving a first set up request over a BMC network, the first BMC sets up the second virtual media on the first bare metal server responsive to receiving a second set up request over the BMC network, and the first BMC boots from the first virtual media responsive to receiving a first boot request over the BMC network.

15. The method of claim 14, wherein a second BMC of the second bare metal server sets up the third virtual media on the second bare metal server responsive to receiving a third set up request over the BMC network, the second BMC sets up the fourth virtual media on the second bare metal server responsive to receiving a fourth set up request over the BMC network, and the second BMC boots from the third virtual media responsive to receiving a second boot request over the BMC network.

16. The method of claim 15, wherein the first set up request, the second set up request, the first boot request, the third set up request, the fourth set up request, and the second boot request are originated and sent by a controller server over a BMC network.
